(19) United States
(12) Patent Application Publication
(10) Pub. No.: US 2004/0180157 A1
(43) Pub. Date: Sep. 16, 2004

(54) Tube laminate and method for producing the same

(76) Inventors: Takao Ishikawa, Hitachi (JP); Shinji Yamada, Tsukuba (JP); Satoru Amou, Hitachi (JP); Kishio Hidaka, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/798,328

(22) Filed: Mar. 12, 2004

(30) Foreign Application Priority Data
Mar. 14, 2003 (JP) 2003-069071

(51) Int. Cl. B32B 1/08

(52) U.S. Cl. 428/34.4

(57) ABSTRACT

It is an object of the present invention to provide a method capable of massively producing a tubular material, without needing time-consuming procedures, which can be easily made into a thin film or laminate.

A method for producing ceramic tubes simply at a low cost using a hybrid coating solution containing of an organic material and metallic element, containing several steps, e.g., for coating, drying and pyropysis. A ceramic tube containing a ceramic containing at least one element selected from the group consisting of C, Ti, Zn, Sn, Al and a rare-earth element, and a Cu compound and a catalyst composed of at least one element selected from the group consisting of Fe, Co, Pt, Ru, Pd and La.

### FIELD OF THE INVENTION

The present invention relates to a tubular material for electronic devices, battery parts, catalysts and magnetic materials, among others.

### BACKGROUND OF THE INVENTION

Carbon nano-tubes can be grown into catalyst particles by treating a hydrocarbon gas as a carbon component in a plasma together with a catalyst, e.g., Fe or Co. They may be also formed into a thin film by a plasma CVD unit for making thin carbon nano-tube films. For example, JP-A-2001-20071 discloses a method which coats a substrate to be treated, placed on a substrate holder, with carbon nano-tubes growing uniformly in the direction perpendicular to the substrate in the presence of a substrate of at least one type of metal selected from the group consisting of Ni, Fe, Co and an alloy thereof as a catalyst.

An oxide tube, on the other hand, has been produced more extensively in the liquid phase from a precursor by the sol-gel process or the like rather than in the vapor phase. Various types of tubular oxides, e.g., Al₂O₃, TiO₂and ZnO, have been produced in the liquid phase. When a fibrous, high-molecular-weight material coated with a hydroxide on the surface is fired, the high-molecular-weight material inside is burnt and removed, and the external hydroxide is oxidized, leaving behind the hollow, fibrous (i.e., tubular) oxide. Its diameter is widely varying from several microns to several nano meters. JP-A-2001-248024 provides a hollow, ceramic fiber having a thickness of 0.1 μm or more by firing an organic fiber, after it is immersed in a liquid containing a metallic compound working as a precursor to be coated with the metallic compound film on the surface.

### SUMMARY OF THE INVENTION

Fibrous or tubular ceramics are made of various materials, e.g., glass, ceramic or carbon. More recently, carbon nano-tubes have been attracting much attention and expected to go into various electronic parts and those related to environments and energy.

There are many types of carbon nano-tube structures, e.g., a sheet of graphene as a monomolecular graphite sheet formed into a seamless cylinder, a plurality of graphene sheets formed into a nested laminate tube, and highway junction type with a core and tube connected to each other. They may contain nitrogen as a constituent element, in addition to carbon. A nitrogen-containing nano-tube is particularly referred to as a CNx nano-tube to be distinguished from carbon nano-tube. Carbon nano-tubes, including CNx tubes, have been recently attracting attention as new materials applicable to widely varying areas from materials science to electronics for their peculiar properties derived from their structures.

Those carbon nano-tubes are generally produced by a plasma CVD unit, where DC arc discharge is triggered between 2 carbon electrodes in a helium or hydrogen gas atmosphere to evaporate carbon in the anode to agglomerate in the deposit formed on the carbon cathode surface. An anode and cathode, both of carbon, are placed in a closed container, and a current necessary for arc discharge is supplied to the electrodes. The resulting deposit formed on the cathode is scraped off. The recovered deposit may contain graphite (soot) and fullerene as impurities, in addition to carbon nano-tubes. The product is immersed in a chemical, as required, to remove the soot first, and then extracted fullerene and carbon nano-tubes are refined and separated from each other with another chemical, to selectively extract carbon nano-tubes.

In order to apply carbon nano-tubes to electronic devices, e.g., electron light-emitting devices, they are incorporated with an organic binder, e.g., electroconductive filler, to prepare paste of good printability, which is printed on a ceramic substrate or the like.

However, the conventional method for producing carbon nano-tubes involves problems, when it uses a conventional vacuum arc evaporation source to form carbon nano-tube films, where soot, fullerene and carbon nano-tubes are produced following vacuum arc evaporation with graphite as a target, and carbon nano-tubes are refined by extraction, as discussed above. As such, it needs very time-consuming steps. Low carbon nano-tube yield is another problem. In addition, the electrode should be replaced after every cycle of deposit production is completed on the cathode, because the carbon anode is largely deformed at the edge. These problems invariably push up the cost greatly, resulting from difficulty in establishing the automatic production line and a large quantity of electric power required for vacuum arc evaporation.

It is also time-consuming to print the produced carbon nano-tubes on a substrate or the like after they are incorporated with an organic binder to prepare paste. Lamination of the printed films one by one by a CVD unit for electronic devices or the like greatly pushes up the cost and is very difficult.

Oxide tubes are produced in the liquid phase. They are difficult to grow selectively in the direction perpendicular to the substrate on which they are spread.

The present invention has been developed to cope with these problems, and provides a method capable of massively producing a tubular material, without needing time-consuming procedures, which can be easily made into a thin film or laminate.

The present invention provides a ceramic tube comprising: a ceramic containing at least one element selected from the group consisting of C, Ti, Zn, Sn, Al and a rare-earth element; a Cu compound; and a catalyst composed of at least one element selected from the group consisting of Fe, Co, Pt, Ru, Pd and La, in order to solve the above problems. Further, the present invention provides the above-mentioned ceramic tube wherein elementary ratio of the Cu compound to the catalyst is 1 to 0.5 in terms of Cu/catalyst. The ceramic tube may contain one of Cl and Br.

The present invention provides a ceramic tube laminate having a structure in which the ceramic tube grows two- or three-dimensionally from a core containing a metal or metal oxide and is connected to an adjacent core, or grows in the direction almost perpendicular to the substrate. The present invention also provides a ceramic tube laminate having a structure in which the ceramic tube is placed between at least two substrates. The ceramic tubes that constitute the tube laminate are of a ceramic containing: at least one element selected from the group consisting of C, Ti, Zn, Sn, Al and a rare-earth element; a Cu compound; and a catalyst composed of at least one element selected from the group consisting of Fe, Co, Pt, Ru, Pd and La, optionally wherein elementary ratio of the Cu compound to the catalyst is 1 to 0.5.

The present invention also provides a coating solution for producing ceramic tubes, which contains: at least one element selected from the group consisting of C, Ti, Zn, Sn, Al and a rare-earth element; a Cu compound; and at least one element selected from the group consisting of Fe, Co, Pt, Ru, Pd and La, with an organic material containing C, N and O being bound to the metallic element, optionally wherein the organic material is of at least one type selected from the group consisting of phenolic resin, acrylic resin, epoxy resin, melamine resin and tetracarboxylic acid dianhydride. The coating solution for producing ceramic tubes may contain one of Cl and Br.

The present invention also provides a method for producing ceramic tubes comprising: a coating step for coating a substrate with a hybrid coating solution comprising an organic material and metallic element; drying step for drying the coated solution to form a film; pyrolysis step for pyrolyzing by heat treatment the dried film in an atmosphere containing oxygen at a low content; and oxidation treatment step for decomposing by oxidation the film to produce hollow shapes in an atmosphere containing oxygen at a high content.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates a process for producing the tube of the present invention.

FIG. 2 is an SEM microgram showing the tubes growing horizontally on the substrate surface.

FIG. 3 is an SEM microgram showing the tube growing in the direction perpendicular to the substrate.

FIG. 4 illustrates a process for producing the tube laminate of the present invention.

### DESCRIPTION OF THE REFERENCE NUMERALS AND SIGNS

1, 12: Tube

2: Core

3: Highway junction type tubes

4: Tube

5: Void

6: Tube growing in the direction perpendicular to the substrate

7: Copper foil

8: Coating film

9: Copper foil coated with a coating film

10: Copper laminate plate

11: Copper foil tube laminate

### DETAILED DESCRIPTION OF THE INVENTION

A carbon nano-tube grows on a catalyst particle, when a hydrocarbon gas as the carbon component is treated in a plasma together with the catalyst, e.g., of Fe or Co. A catalyst component and hydrocarbon gas as the carbon component are used also for production of the carbon nano-tube of the present invention. The CVD process can easily grow the tubes on a catalyst, because it supplies a hydrocarbon gas onto the catalyst particles. By contrast, the pyrolysis process for the present invention thermally treats a coating solution spread on a substrate, which tends to limit organic materials as the carbon source and makes it difficult to produce carbon nano-tubes. It produces carbon nano-tubes in a low yield and an uneven film, because an organic material it uses evaporates when pyrolyzed, and the resulting gases not contacting with the catalyst are released out of the system without being treated, leaving part of the gases to be formed into carbon nano-tubes on the catalyst. Therefore, the present invention uses an organic/inorganic hybrid with a catalyst component bound to the organic material molecules as the carbon source. The hybrid material, when spread on a substrate and pyrolyzed, gives carbon nano-tubes in a high yield and a uniform film, because the catalyst component is uniformly dispersed and comes into contact with the carbon source.

The inventors of the present invention have extensively studied the catalyst component to find that a metal of Fe, Co, Pt, Pd, Ru or La or a compound thereof can be useful. However, they have also found that a catalyst composed of the above metal or compound alone cannot give tubes in a high yield. The above metal or compound works as a catalyst to produce fibers of an organic resin as the carbon source by carbonation. An organic resin as the carbon source is carbonated at a temperature lower than catalytic reaction temperature for forming the fibers, with the result that the resin is graphitized before it is made fibrous to deteriorate tube yield. In the presence of a catalyst incorporated with a Cu compound as a promoter, the graphitized carbon can be gasified and then made fibrous. It is important to carefully determine content of the Cu compound for the catalytic reaction, because the gasified carbon source will be released from the reaction system before being reacted to deteriorate tube yield. The inventors of the present invention have found, after having extensively studied to determine an optimum catalyst composition, that elementary ratio of the Cu compound to the catalyst is preferably in a range from 1 to 0.5 in terms of Cu/catalyst.

Quantity of the catalyst is also important for these reactions, because it determines tube shape. The reaction in the presence of a large quantity of catalyst forms ceramic cores around the catalyst metal element, from which carbon tubes radiate. At the same time, the carbon tubes radiating from each core come into contact with, and are bound to, the adjacent cores. As a result, the carbon tube structure is characterized by highway junction shape with the cores connected to each other via the carbon tube. When the coating solution of the present invention is spread and pyrolyzed on a substrate, the carbon tubes tend to be oriented in the X-Y axis direction on the substrate rather than in the Z axis direction. In the presence of a small quantity of the catalyst, on the other hand, the carbon source is massively gasified because of an insufficient quantity of the catalytic sites, and the gases released are recombined on the substrate, with the result that the fibers tend to grow in the direction perpendicular to the substrate.

The present invention is described by EXAMPLES, which by no means limit the present invention.

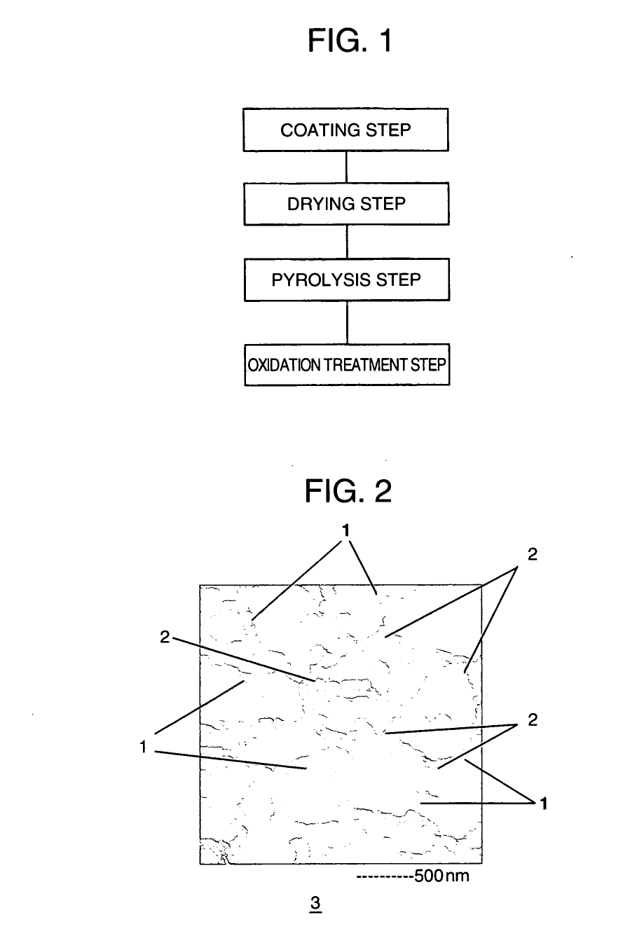

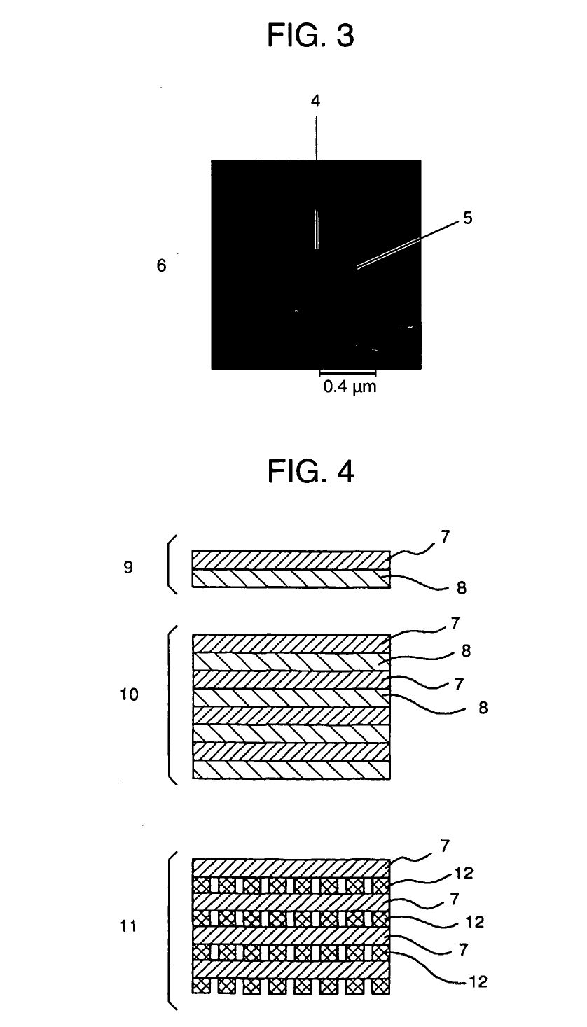

FIG. 1 illustrates a process for producing the carbon nano-tube of the present invention. FIGS. 2 and 3 are SEM micrograms showing the tubes prepared by the coating method of the present invention. FIG. 2 shows highway junction type tubes 3 in which tube 1 grows two- or three-dimensionally from the cores 2 containing a metal or metal oxide, where the adjacent cores are connected to each other. FIG. 3 shows the vertically growing tube 6 with the tube 4 growing in the direction perpendicular to the substrate and with void 5 extending in the direction perpendicular to the substrate. These carbon tubes are 3 μm to 30 nm in diameter size and 2 μm to 10 nm in inner diameter. These tubes have a varying shape depending on properties and composition of the coating solution as a precursor, catalyst quantity and pyrolysis conditions.

The tubes of highway junction structure, shown in FIG. 2, with fine tubes radiating in all directions from the core mainly composed of a catalyst component, are effective when various parts are to be mounted on the substrate, because they grow horizontally on the substrate surface. The tubes growing in the direction perpendicular to the substrate, shown in FIG. 3, are effective for electrodes, because they have insides exposed to the exterior, keep a high surface area and directly come into contact with the substrate to have a lower contact resistance than those prepared by spreading powder. These tubes of different structure can be prepared by the coating method and provide a material at a low cost.

Next, the coating solution for the present invention is described. It is composed of an organic resin as a carbon source, at least one type of catalyst component selected from the group consisting of Fe, Co, Pt, Pd, Ru and La, and metallic Cu or a compound thereof as a cocatalyst.

The organic resin as a carbon source is not limited so long as it contains oxygen and nitrogen. Those resins useful for the present invention include polyamide, phenolic, acrylic, epoxy, melamine resin. A resin containing oxygen and nitrogen is easily bound to the metallic element as the incorporated catalyst to efficiently disperse the catalyst component.

The catalyst component of Fe, Co, Pt, Pd, Ru or La may be in the form of salt, e.g., nitrate or chloride, or organometallic compound, e.g., alkoxide. Commercial superfine particles are also useful. Particle size of the catalyst component determines size of the tube produced, and hence is preferably selected for desired tube size. Quantity of the catalyst component is not limited, but tube yield may be deteriorated in the presence of an excessive quantity.

Metallic Cu or a compound thereof for the promoter (cocatalyst) may be in the form of salt, e.g., nitrate or chloride, or organimetallic compound, e.g., alkoxide, as the the case with the catalyst component. Size of the promoter is not limited, but tube yield may be deteriorated in the presence of an excessive quantity, and the product carbon film may be of merely carbonated resin in the presence of an insufficient quantity. The promoter is incorporated to have an elementary Cu/catalyst ratio of 1 to 0.5.

Next, each production step is described in detail.

Coating step is for coating a substrate with a coating solution. The coating method is not limited, and may be spin, spray, dip or roll coating. The substrate material is not limited, so long as it is sufficiently resistant treatment temperature and oxidation. It is normally of an inorganic material, e.g., glass, ceramic or metal. It may be of a heat-resistant, high-molecular-weight material, e.g., Teflon (registered trademark) or polyimide, when treatment temperature is relatively low. Moreover, the coating solution may be dried and fired to produce carbon tube powder in the absence of a substrate.

The drying step is for drying the coating solution spread on a substrate to have a film which lacks fluidity by removing the solvent. The drying procedure is not limited, and the coating solution may be treated by hot wind, hot plate or oven. It may be treated in any atmosphere, e.g., in air, under a vacuum or in an inert gas.

The pyrolysis step is for thermally treating the coating film produced in the drying step. In this step, the resin in the form of film is transformed into carbon fibers. The resin as a carbon source evaporates when carbonated, and the resulting gases are formed into fibers by the reaction over the catalyst. The resin is therefore preferably treated under a vacuum or in an inert gas atmosphere to prevent it from being burnt. It may be treated in a gas atmosphere incorporated with hydrogen gas. Temperature is preferably increased rapidly in the heat treatment step to efficiently evaporate the resin, preferably by an infrared lamp or radiofrequency heater. The resin is heated at 350 to 850° C. for several to several tens minutes, although these conditions vary depending on catalyst type and resin composition. The fibers grow by the catalytic reaction and hence very rapidly. The reaction involving the coating film is completed and the carbon source is depleted rapidly in this step, unlike the step proceeding by the aid of a CVD unit, to which a starting gas is continuously supplied. As a result, the fibers are produced in a short time.

The oxidation treatment step is for forming the fibrous product into tubes. Each of the carbon fibers produced by the catalytic reaction is covered with a dense, graphitized layer, with amorphous carbon inside. Graphite is not burnt at several hundreds degrees Celsius, whereas amorphous carbon is burnt. Therefore, when the fiber is heated in an oxygen-containing atmosphere, amorphous carbon inside is burnt and removed, leaving behind the outer graphite layer to produce a tube. The oxidation treatment step is carried out at 350 to 850° C. for 3 to 60 minutes, although these conditions vary depending on catalyst type incorporated and remaining.

### EXAMPLES

### Example 1

Carbon tubes were prepared using a phenolic resin as the carbon source and Fe as the catalyst component.

An ethanol solution of iron nitrate was incorporated with 2,4-pentadione, and the resulting mixture was heated at 80° C. for 1 hour with stirring to form an Fe complex as a compound containing the catalyst component.

Next, a phenolic resin (4900, trade name) commercially available from Hitachi Chemical Co., Ltd. was incorporated with the above compound containing the catalyst component at 20% by weight as FeO, based on the solid resin. The resulting mixture was incorporated with copper nitrate as a promoter at a Cu/Fe elementary ratio of 0.8 to prepare a coating solution.

A glass substrate was coated with the above coating solution to prepare the carbon tubes by the process illustrated in FIG. 1, where the pyrolysis step was carried out at 850° C. for 5 minutes and oxidation treatment step at 800° C. for 1 hour.

### Example 2

Carbon tubes were prepared using a phenolic resin as the carbon source and Fe as the catalyst component.

An ethanol solution of iron nitrate was incorporated with 2,4-pentadione, and the resulting mixture was heated at 80° C. for 1 hour with stirring to form an Fe complex as a compound containing the catalyst component.

Next, a phenolic resin (Hitachi Chemical, 4900) was incorporated with the above compound containing the catalyst component at 5% by weight as FeO, based on the solid resin. The resulting mixture was incorporated with copper nitrate as a promoter at a Cu/Fe elementary ratio of 0.8 to prepare a coating solution.

A glass substrate was coated with the above coating solution to prepare the carbon tubes by the process illustrated in FIG. 1, where the pyrolysis step was carried out at 850° C. for 5 minutes and oxidation treatment step at 800° C. for 1 hour.

### Example 3

Carbon tubes were prepared using a phenolic resin as the carbon source and Co as the catalyst component.

An ethanol solution of cobalt nitrate was incorporated with 2,4-pentadione, and the resulting mixture was heated at 80° C. for 1 hour with stirring to form a Co complex as a compound containing the catalyst component.

Next, a phenolic resin (Hitachi Chemical, 4900) was incorporated with the above compound containing the catalyst component at 5% by weight as CoO, based on the solid resin. The resulting mixture was incorporated with copper nitrate as a promoter at a Cu/Co elementary ratio of 0.8 to prepare a coating solution.

A glass substrate was coated with the above coating solution to prepare the carbon tubes by the process illustrated in FIG. 1, where the pyrolysis step was carried out at 850° C. for 5 minutes and oxidation treatment step at 800° C. for 1 hour.

### Example 4

Carbon tubes were prepared using a phenolic resin as the carbon source and Pd as the catalyst component.

An ethanol solution of palladium chloride was incorporated with 2,4-pentadione, and the resulting mixture was heated at 80° C. for 1 hour with stirring to form a Pd complex as a compound containing the catalyst component.

Next, a phenolic resin (Hitachi Chemical, 4900 was incorporated with the above compound containing the catalyst component at 5% by weight as PdO, based on the solid resin. The resulting mixture was incorporated with copper nitrate as a promoter at a Cu/Pd elementary ratio of 0.8 to prepare a coating solution.

A glass substrate was coated with the above coating solution to prepare the carbon tubes by the process illustrated in FIG. 1, where the pyrolysis step was carried out at 850° C. for 1 minute and oxidation treatment step at 700° C. for 1 hour.

### Example 5

Carbon tubes were prepared using a phenolic resin as the carbon source and Ru as the catalyst component.

An ethanol solution of ruthenium chloride was incorporated with 2,4-pentadione, and the resulting mixture was heated at 80° C. for 1 hour with stirring to form a Ru complex as a compound containing the catalyst component.

Next, a phenolic resin (Hitachi Chemical, 4900 was incorporated with the above compound containing the catalyst component at 5% by weight as RuO₂, based on the solid resin. The resulting mixture was incorporated with copper nitrate as a promoter at a Cu/Ru elementary ratio of 0.8 to prepare a coating solution.

A glass substrate was coated with the above coating solution to prepare the carbon tubes by the process illustrated in FIG. 1, where the pyrolysis step was carried out at 850° C. for 2 minute and oxidation treatment step at 800° C. for 1 hour.

### Example 6

Carbon tubes were prepared using a phenolic resin as the carbon source and Pt as the catalyst component.

An ethanol solution of chloroplatinic acid was incorporated with 2,4-pentadione, and the resulting mixture was heated at 80° C. for 1 hour with stirring to form a Pt complex as a compound containing the catalyst component.

Next, a phenolic resin (Hitachi Chemical, 4900) was incorporated with the above compound containing the catalyst component at 5% by weight as PtO, based on the solid resin. The resulting mixture was incorporated with copper nitrate as a promoter at a Cu/Pt elementary ratio of 0.8 to prepare a coating solution.

A glass substrate was coated with the above coating solution to prepare the carbon tubes by the process illustrated in FIG. 1, where the pyrolysis step was carried out at 850° C. for 1 minute and oxidation treatment step at 800° C. for 1 hour.

### Example 7

Carbon tubes were prepared using a phenolic resin as the carbon source and Fe—La as the catalyst component.

An ethanol solution of iron nitrate and lanthanum nitrate was incorporated with 2,4-pentadione, and the resulting mixture was heated at 80° C. for 1 hour with stirring to form an Fe—La complex as a compound containing the catalyst component, where Fe/La ratio was set at 1/0.5.

Next, a phenolic resin (Hitachi Chemical, 4900) was incorporated with the above compound containing the catalyst component at 5% by weight as FeO, based on the solid resin. The resulting mixture was incorporated with copper nitrate as a promoter at a Cu/Fe elementary ratio of 0.8 to prepare a coating solution.

A glass substrate was coated with the above coating solution to prepare the carbon tubes by the process illustrated in FIG. 1, where the pyrolysis step was carried out at 850° C. for 2 minutes and oxidation treatment step at 800° C. for 1 hour.

Table 1 summarizes outer diameter, inner diameter and shape of the carbon tubes prepared in EXAMPLES 1 to 7. The tubes have a highway junction structure with fine tubes radiating in all directions from the core mainly composed of a catalyst component, as shown in FIG. 2, when the catalyst is used massively to provide a large number of tube-forming sites, as in EXAMPLE 1. By contrast, the tubes growing in the direction perpendicular to the substrate are produced (FIG. 3) in the presence of an insufficient quantity of catalyst, as in EXAMPLES 2 to 7. The carbon source is used in a limited quantity for the present invention as compared with that for a process involving CVD or the like, and gives the tubes having a varying shape depending on catalyst quantity. Moreover, 2 or more types of catalyst components may be used for producing the tubes, as in EXAMPLE 7.

TABLE 1

| | Outer | Inner | |
|---|---|---|---|
| | diameter | diameter | Shape |
| EXAMPLE 1 | 80 nm | 50 nm | Highway junction |
| EXAMPLE 2 | 800 nm | 80 nm | Vertically growing tube |
| EXAMPLE 3 | 650 nm | 580 nm | Vertically growing tube |
| EXAMPLE 4 | 2 μm | 300 nm | Vertically growing tube |
| EXAMPLE 5 | 1 μm | 200 nm | Vertically growing tube |
| EXAMPLE 6 | 1.5 μm | 280 nm | Vertically growing tube |
| EXAMPLE 7 | 850 nm | 120 nm | Vertically growing tube |

### Example 8

A mixture of palladium chloride and ethanol (molar ratio: ½ was added to a solution of sBPDA (3,3′-4,4′-biphenyltetracarboxylic anhydride) dissolved in N-methylpyrrolidone, and the resulting mixture was stirred for 2 hours, where Pd/sBPDA molar ratio was set at 1/1. It was then incorporated with copper nitrate as a promoter at a Cu/Pd (catalyst component) elementary ratio of 0.8 to prepare a coating solution.

A glass substrate was coated with the above coating solution to prepare the carbon tubes by the process illustrated in FIG. 1, where the pyrolysis step was carried out at 650° C. for 2 minutes and oxidation treatment step at 550° C. for 1 hour.

### Example 9

A mixture of palladium chloride and ethanol (molar ratio: ½ was added to a solution of epoxy resin dissolved in methylethylketone, and the resulting mixture was stirred for 2 hours, where Pd/epoxy resin ratio was set at ⅕ by weight. It was then incorporated with copper nitrate as a promoter at a Cu/Pd (catalyst component) elementary ratio of 0.8 to prepare a coating solution.

A glass substrate was coated with the above coating solution to prepare the carbon tubes by the process illustrated in FIG. 1, where the pyrolysis step was carried out at 650° C. for 2 minutes and oxidation treatment step at 550° C. for 1 hour.

### Example 10

A mixture of palladium chloride and ethanolamine (molar ratio: ½ was added to a solution of acrylic resin dissolved in methylethylketone, and the resulting mixture was stirred for 2 hours, where Pd/acrylic resin ratio was set at ⅕ by weight. It was then incorporated with copper nitrate as a promoter at a Cu/Pd (catalyst component) elementary ratio of 0.8 to prepare a coating solution.

A glass substrate was coated with the above coating solution to prepare the carbon tubes by the process illustrated in FIG. 1, where the pyrolysis step was carried out at 650° C. for 2 minutes and oxidation treatment step at 550° C. for 1 hour.

Table 2 summarizes outer diameter, inner diameter and shape of the carbon tubes prepared in EXAMPLES 8 to 10. It is demonstrated that the carbon tubes can be produced by use of polyimide (imide), epoxy or acrylic resin, in addition to phenolic resin, as the carbon source. The tubes can be also produced by other resins, e.g., melamine, furan or mixed resin.

TABLE 2

| | Outer | Inner | |
|---|---|---|---|
| | diameter | diameter | Shape |
| EXAMPLE 8 | 800 nm | 100 nm | Vertically growing tube |
| EXAMPLE 9 | 1.5 μm | 300 nm | Vertically growing tube |
| EXAMPLE 10 | 1.5 μm | 350 nm | Vertically growing tube |

### Example 11

A mixture of palladium chloride and ethanoamine (molar ratio: ½ was added to a solution of acrylic resin dissolved in methylethylketone, and the resulting mixture was stirred for 2 hours, where Pd/acrylic resin ratio was set at ⅕ by weight. It was then incorporated with copper nitrate as a promoter at a Cu/Pd (catalyst component) elementary ratio of 1.0 to prepare a coating solution.

A glass substrate was coated with the above coating solution to prepare the carbon tubes by the process illustrated in FIG. 1, where the pyrolysis step was carried out at 650° C. for 2 minutes and oxidation treatment step at 550° C. for 1 hour.

### Example 12

The carbon tubes were prepared in the same manner as in EXAMPLE 11, except that Cu/Pd (catalyst component) elementary ratio was set at 0.5.

### COMPARATIVE EXAMPLE 1

The carbon tubes were prepared in the same manner as in EXAMPLE 11, except that Cu/Pd (catalyst component) elementary ratio was set at 0.4.

### COMPARATIVE EXAMPLE 2

The carbon tubes were prepared in the same manner as in EXAMPLE 11, except that Cu/Pd (catalyst component) elementary ratio was set at 1.2.

The tubes (outer diameter: 1.5 to 2 μm, inner diameter: 200 to 400 nm) growing in the direction perpendicular to the substrate were produced in EXAMPLES 11 and 12. In COMPARATIVE EXAMPLE 1, the catalytic reaction did not proceed sufficiently because of low Cu ratio of 0.4, and the product was characterized by s structure with carbon nano-particles on bulk carbon. In COMPARATIVE EXAMPLE 2, on the other hand, the catalytic reaction proceeded excessively because of high Cu ratio to produce the tubes only in places on the substrate and in an insufficient yield, although they grew in the direction perpendicular to the substrate. Therefore, the tubes growing in the direction perpendicular to the substrate are produced satisfactorily at a Cu ratio of 0.5 to 1.0.

The carbon nano-tubes can be produced in the manner described above. The oxide tubes can be produced in a similar manner, except that oxygen is present at a certain content in the heating step. A mixture of carbon and metallic oxide, with the latter richer in the outer periphery while amorphous carbon richer inside, is formed during the heating step, because it is made fibrous on the catalyst together with the carbon source. The complete tube shape is difficult to produce in the oxidation treatment step, because the metallic oxide cannot be burnt and removed, with the result that the product shows a cross-section with fibers forming a cobweb-shape structure. Moreover, it has a porous structure, because carbon present to some extent on the peripheral surface area is removed to leave voids. The metallic element and carbon are highly dispersed in each other already in the precursor, with the result that carbon in the fibrous product formed in the heating step is not graphitized easily, and mostly kept amorphous even in the outer peripheral area. However, it may be graphitized locally to give graphite-containing oxide tubes.

### Example 13

Tin oxide tubes were prepared by incorporating a coating solution with a tin compound.

A mixture of palladium chloride and ethanolamine (molar ratio: ½ was added to a solution of acrylic resin dissolved in methylethylketone, and the resulting mixture was stirred for 2 hours, where Pd/acrylic resin ratio was set at ⅕ by weight. It was then incorporated with copper nitrate as a promoter at a Cu/Pd (catalyst component) elementary ratio of 0.8, and then with tin chloride dissolved in ethanol, to prepare a coating solution, where resin solid/SnO₂ ratio was set at ⅓ by weight.

A glass substrate was coated with the above coating solution to prepare the tin oxide tubes by the process illustrated in FIG. 1, where the pyrolysis step was carried out at 650° C. for 2 minutes and oxidation treatment step at 550° C. for 1 hour.

### Example 14

Tin oxide tubes were prepared by incorporating a coating solution with a compound oxide of SnO₂-TiO₂.

A mixture of palladium chloride and ethanolamine (molar ratio: ½ was added to a solution of acrylic resin dissolved in methylethylketone, and the resulting mixture was stirred for 2 hours, where Pd/acrylic resin ratio was set at ⅕ by weight. It was then incorporated with copper nitrate as a promoter at a Cu/Pd (catalyst component) elementary ratio of 0.8, and then with titanium chloride and tin chloride dissolved in ethanol, to prepare a coating solution, where TiO₂/SnO₂ ratio was set at 5/1 by weight and resin solid/TiO₂ ratio set at ⅓ by weight.

A glass substrate was coated with the above coating solution to prepare the SnO₂-TiO₂ compound oxide tubes by the process illustrated in FIG. 1, where the pyrolysis step was carried out at 750° C. for 2 minutes and oxidation treatment step at 550° C. for 1 hour.

The ceramic tubes prepared in EXAMPLES 13 and 14, 500 to 300 nm in outer diameter and 80 to 50 nm in inner diameter, grew in the direction perpendicular to the substrate, as observed by scanning electron microscope (SEM). Each oxide tube produced above was not a complete tube, showing a cross-section with fibers forming a cobweb-shape structure. As described above, it is demonstrated that the present invention can provide oxide tubes, and also compound oxide tubes containing 2 or more types of oxides. The inventors of the present invention have also carried out the similar tests with ZnO, Al₂O₃, SiO₂, among others, to find that the tubes similar to those prepared in EXAMPLES 13 and 14 can be prepared, and that several types of oxides can be compounded. These oxide tubes are directly connected to the substrate, and hence have a low contact resistance and large surface area. As such, they are useful for fuel and photovoltaic cell electrodes. They can be prepared by the coating method and provide a material at a low cost.

As described above, the present invention can prepare tubes of carbon and various oxides by the coating method on a substrate. Those tubes described in EXAMPLES are formed on a single-layer substrate. The present invention can also prepare laminates, as described in EXAMPLE 15.

### Example 15

In the present invention, the coating film as the tube precursor on a substrate is of a resin, and hence can work as an adhesive agent to form a laminate when the drying step is completed. FIG. 4 illustrates a flow of the lamination step. A substrate is put on a dried film formed on another substrate to have some thickness, and this procedure is repeated as many times as required to have an n-layered laminate. The resulting laminate is heated to have a precursor laminate with each coating film put between the substrates working as an adhesive agent to bond these substrates to each other when it is hardened. The substrates may be the same or different, and so are the coating films.

One embodiment of process for producing a laminate is described by referring to FIG. 4, where a coating solution is spread as an adhesive agent on a substrate and the resulting laminate is thermally treated.

The coating solution prepared in EXAMPLE 5 was spread on the copper foil 7 by spraying, and dried at 160° C. to prepare the copper foil 9 coated with the film 8 on the copper foil 7. Several sheets of the foils 9 were prepared. They were put on one another and hot-pressed at 3 kg/cm² and 220° C. to prepare the copper laminate 10. The copper laminate 10 was treated at 650° C. for 2 minutes under a vacuum, and then by oxidized at 550° C. for 1 hour in air, to prepare the copper foil/tube laminate 11. The laminate 11 had the tubes 12 growing in the direction perpendicular to the copper foil surface, where the adjacent copper foils 7 were bonded to each other via the grown tubes 12. Thus, the present invention can produce the laminate with the copper foils bonded to each other via the tubes growing in the direction perpendicular to the foil surfaces. These laminates are useful for various battery electrodes. The laminate as an electrode material has a larger surface area and lower contact resistance than the one with powder spread on a copper substrate. The tubes can be produced by the coating method and hence at a reduced cost.

The substrate for the laminate is not limited to copper foil. It may be of a ceramic, e.g., alumina or aluminum nitride; laminate of a ceramic coated with an electroconductive film; or cladding material, e.g., of aluminum or titanium. It is preferable to adopt tube forming and oxidation treatment conditions suitable for the substrate, depending on its resistance to heat and oxidation. The laminate, which comprises a substrate resistant to heat, oxidation or the like, can be an electrode material serviceable at high temperature in air.

It should be further understood by those skilled in the art that although the foregoing description has been made on embodiments of the invention, the invention is not limited thereto and various changes and modifications may be made without departing from the spirit of the invention and the scope of the appended claims.

### Effects

The present invention provides a method for producing ceramic tubes in high productivity, and at a low electric power consumption and production cost, which can easily form thin films and laminates.

What is claimed is:

1. A ceramic tube comprising:
a ceramic containing at least one element selected from the group consisting of C, Ti, Zn, Sn, Al and a rare-earth element;
a Cu compound; and
a catalyst composed of at least one element selected from the group consisting of Fe, Co, Pt, Ru, Pd and La.

2. The ceramic tube according to claim 1, wherein elementary ratio of said Cu compound to said catalyst is 1 to 0.5 in terms of Cu/catalyst.

3. The ceramic tube according to claim 1 which contains one of Cl and Br.

4. A ceramic tube laminate having a structure in which a ceramic tube is laminated onto at least one side of a substrate and the ceramic tube grows two- or three-dimensionally from a core containing a metal or metal oxide and is connected to an adjacent core.

5. A ceramic tube laminate having a structure in which the ceramic tube grows onto at least one side of a substrate in the direction almost perpendicular to the substrate.

6. A ceramic tube laminate having a structure in which the ceramic tube of claim 1 is placed between at least two substrates.

7. The ceramic tube laminate according to claim 4 which comprises a ceramic tube comprising:
a ceramic containing at least one element selected from the group consisting of C, Ti, Zn, Sn, Al and a rare-earth element;
a Cu compound; and
a catalyst composed of at least one element selected from the group consisting of Fe, Co, Pt, Ru, Pd and La.

8. A coating solution for producing ceramic tubes, which contains:
at least one element selected from the group consisting of C, Ti, Zn, Sn, Al and a rare-earth element;
Cu compound; and
at least one element selected from the group consisting of Fe, Co, Pt, Ru, Pd and La;
wherein an organic material containing C, N and O is bound to the metallic element.

9. The coating solution according to claim 8, wherein said organic material is of at least one type selected from the group consisting of phenolic resin, acrylic resin, epoxy resin, melamine resin and tetracarboxylic acid dianhydride.

10. The coating solution according to claim 8 which contains one of Cl and Br.

11. A method for producing ceramic tubes comprising:
a coating step for coating a substrate with a hybrid coating solution comprising an organic material and metallic element;
drying step for drying the coated solution to form a film;
pyrolysis step for pyrolyzing by heat treatment the dried film in an atmosphere containing oxygen at a low content; and
oxidation treatment step for decomposing by oxidation the film to produce hollow shapes in an atmosphere containing oxygen at a high content.
